(19) United States
(12) Patent Application Publication
(10) Pub. No.: US 2023/0189725 A1
(43) Pub. Date: Jun. 22, 2023

(54) Electric blower apparatus having a noise cover

(71) Applicant: Andreas Stihl AG & Co. KG, Waiblingen (DE)

(72) Inventors: Roland Mandel, Stuttgart (DE); Sebastian Piekarek, Stuttgart (DE); Markus Koenig, Leinfelden-Echterdingen (DE); Andrea Hein, Ehningen (DE); Markus Zauner, Fellbach (DE); Dennis Karl, Freiberg am Neckar (DE); Thilo Stuerzel, Remshalden (DE); Mathias Schmitz, Waiblingen (DE)

(21) Appl. No.: 18/067,876

(22) Filed: Dec. 19, 2022

(30) Foreign Application Priority Data
Dec. 21, 2021 (EP) 21 216 636.7

(51) Int. Cl. A01G 20/47; F04D 29/66

(52) U.S. Cl. CPC A01G 20/47; F04D 29/66

(57) ABSTRACT

The disclosure relates to an electric blower apparatus having a blower spiral which has a first axial end wall, a second axial end wall and a blower air outlet. An electric motor which drives a fan wheel rotating in the blower spiral is held on the first axial end wall, the fan wheel inducting ambient air by way of an intake opening in the second axial end wall. A cover element, the cover surface thereof being configured so as to be larger than the air inlet surface of the intake opening, is disposed in front of the intake opening. To induct a large quantity of ambient air with little noise, it is provided that the cover element is configured as a cover plate, wherein an annular gap which forms the intake channel for the direct access of ambient air is configured between the plate edge and the blower spiral.

### CROSS-REFERENCE TO RELATED APPLICATIONS

This application claims priority of European patent application no. 21 216 636.7, filed Dec. 21, 2021, the entire content of which is incorporated herein by reference.

### TECHNICAL

The disclosure relates to an electric blower apparatus having a blower spiral which has a first axial end wall, a second axial end wall and a blower air outlet. An electric motor, the drive shaft thereof being connected to a fan wheel rotating in the blower spiral, is disposed on the first axial end wall. An intake opening having an air inlet surface to the fan wheel is provided in the second axial end wall. A cover element having a cover surface is held in front of the air inlet surface of the intake opening, the cover surface being at a spacing from the air inlet opening. The cover surface of the cover element is configured so as to be larger than the air inlet surface of the intake opening. The intake opening is connected to an intake channel by way of which ambient air from the environment of the blower apparatus is fed to the intake opening.

### BACKGROUND

The entire operating air of the blower apparatus is fed to the intake opening by way of the intake channel, this leading to high flow velocities at the air inlet of the intake channel. This results in a higher risk of foreign particles which may block the air inlet being ingested.

### SUMMARY

It is an object of the disclosure to provide an electric blow apparatus in such a manner that only a low noise emission emanates from the blower apparatus and, for the avoidance of foreign particles being ingested, the inflow velocity of the operating air into the intake channel to the blower spiral is reduced.

The object is, for example, achieved via an electric blower apparatus including: a blower spiral having a first axial end wall, a second axial end wall, and a blower air outlet; an electric motor disposed on the first axial end wall; a fan wheel configured to rotate in the blower spiral; the electric motor having a drive shaft connected to the fan wheel; the second axial end wall of the blower spiral defining an intake opening; the intake opening defining an air inlet surface; a cover element disposed in front of the air inlet surface; the cover element defining a cover surface disposed at a spacing (z) from the air inlet surface; the cover surface being configured so as to be larger than the air inlet surface; the intake opening being connected to an air intake channel configured to feed ambient air from an environment of the electric blower apparatus; the cover element being configured as a cover plate having an encircling outer plate edge; the encircling outer plate edge and the blower spiral mutually defining an annular gap between each other; and, the annular gap forming the intake channel for direct access of ambient air from the environment of the blower apparatus into the intake opening.

Provided as the cover element for the intake opening of the blower spiral is a cover plate which has an encircling outer plate edge. The intake channel to the covered intake opening, which is necessary for the operating air, is formed by the annular gap which is configured between the plate edge and the blower spiral when the cover plate is disposed in front of the intake opening. Direct access of ambient air from the environment of the blower apparatus into the intake opening to the fan wheel is guaranteed by way of the annular gap. The annular gap possesses a large inflow opening such that the inflow velocity of the required operating air into the annular gap is low. The risk of ingesting foreign particles is reduced.

As a result of the cover element being disposed at a spacing in front of the intake opening, any direct emission of noise from the intake opening into the environment is prevented. The electric blower apparatus according to the disclosure has a silent operating noise.

An insulation element can advantageously be disposed between the cover plate and the intake opening. The insulation element can in particular be an insulation mat by way of which the emission of noise is reduced and the perceptible operating noise of the blower apparatus is furthermore reduced. It is expediently provided that the cover plate is configured as the support of the insulation element.

In an embodiment of the disclosure, the cover plate has a base having a plate edge that is raised in relation to the base. The arrangement is expediently chosen such that the base lies opposite the intake opening and the plate edge delimits the annular gap between the blower spiral and the cover plate. It is provided in particular that the base has a larger spacing from the air inlet surface of the intake opening than the plate edge.

It can be expedient for the cover plate to be configured so as to be curved. The concave side of the cover plate advantageously faces the intake opening. The concave curvature leads to a further reduction in the noise emissions.

The arrangement is chosen such that the rotation axis of the drive shaft of the electric motor is perpendicular to the cover plate, in particular perpendicular to the base of the cover plate. In particular, the cover plate, expediently the base of the cover plate, lies parallel to the air inlet surface of the intake opening.

A further reduction of the noise emissions is achieved when the blower spiral is held on a back plate and the cover plate is inclined at an inclination angle in relation to the back plate. An inclination angle of this type of the cover plate in relation to the back plate is advantageously in the range from 3° to 20°, the inclination angle being in particular 10°.

The ratio between the size of the cover element, in particular of the cover plate, and the size of the intake opening is chosen in such a manner that the maximum diameter S of the cover plate, measured at the height level of the plate edge, is 1.5 times to 3.5 times, in particular 2.6 times the diameter D of the intake opening.

The annular gap configured between the plate edge and the blower spiral extends across a circumferential angle of up to 360°. The operating air from the environment of the blower apparatus, by way of the circumferential angle of the annular gap, can flow unimpeded into the annular gap because the inflow opening of the annular gap extends across the circumferential angle of the annular gap per se. The configuration is chosen such that the intake channel formed by the annular gap extends across at least 60% to 90% of the circumferential angle W of the cover plate. The cover plate is held on the blower spiral by way of fastening elements, as a result of which the annular gap is interrupted. However, this interference or interruption of the annular gap by a fastening element does not have any significant effects because the fastening element in the circumferential direction extends only across a few angular degrees of the circumferential angle. A fastening element advantageously extends only across 3° to 10° of the circumferential angle, in particular across exactly 8° of the circumferential angle. A cutout by way of which ambient air can enter the annular gap is expediently provided in a fastening element.

### BRIEF DESCRIPTION OF DRAWINGS

The invention will now be described with reference to the drawings wherein:

FIG. 1 shows a blower apparatus having a noise cover according to the disclosure in a perspective view from the rear;

FIG. 2 shows a schematic illustration of an axial section through the blower apparatus according to FIG. 1;

FIG. 3 shows an axial section through the drive motor and the blower spiral of the blower apparatus according to FIG. 1;

FIG. 4 shows a view onto the blower apparatus according to FIG. 1 from the rear;

FIG. 5 shows a view of the blower spiral having a cover element as the noise cover of the intake opening;

FIG. 6 shows a perspective view of the blower spiral according to FIG. 5; and,

FIG. 7 shows a further perspective view of the blower spiral according to FIG. 5.

### DETAILED DESCRIPTION

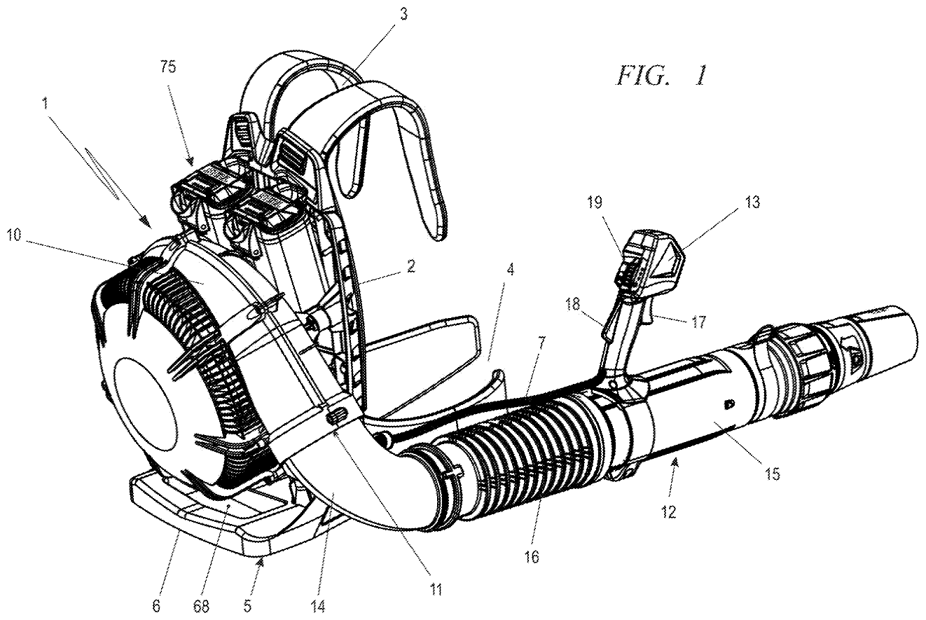

The embodiment of a blower apparatus 1 illustrated in FIG. 1 is a backpack blower apparatus. Other embodiments of the blower apparatus, such as a hand-held blower apparatus, a mobile blower apparatus or the like, can also be equipped with the subject-matter of the disclosure.

The backpack blower apparatus 1 includes a back plate 2 which via schematically illustrated shoulder straps 3 and a schematically illustrated hip belt 4 is established on the back of a user. The back plate 2 is part of a carrier 5 which is provided with a base plate 6. The back plate 2 and the base plate 6 form the carrier 5 which in the lateral view is of an L-shaped configuration. The base plate 6 advantageously has a central opening 68. Ambient air from below the blower apparatus 1 can be inducted by way of the opening 68. The base plate 6 can expediently be configured as a bracket, in particular as a U-shaped bracket. The ends of the bracket are established on the back plate 2. The bracket is advantageously composed of a metallic material or of a metal alloy.

A blower spiral 10, which has an outlet 11 for connecting a blower tube 12, is held on the back plate 2. A handle 13 for holding and guiding the blower tube 12 is established on the blower tube 12. The blower tube 12 has a rear rigid tube section 14 for connecting to the outlet 11 of the blower spiral 10. The tube section 14 is expediently held so as to be rotatable in the outlet 11. A flexible tube section 16, which is connected to a front rigid tube section 15, is connected to the rear tube section 14. The handle 13 is established on the front tube section 15. The front tube section 15 is pivotable in all spatial directions relative to the rear tube section 14.

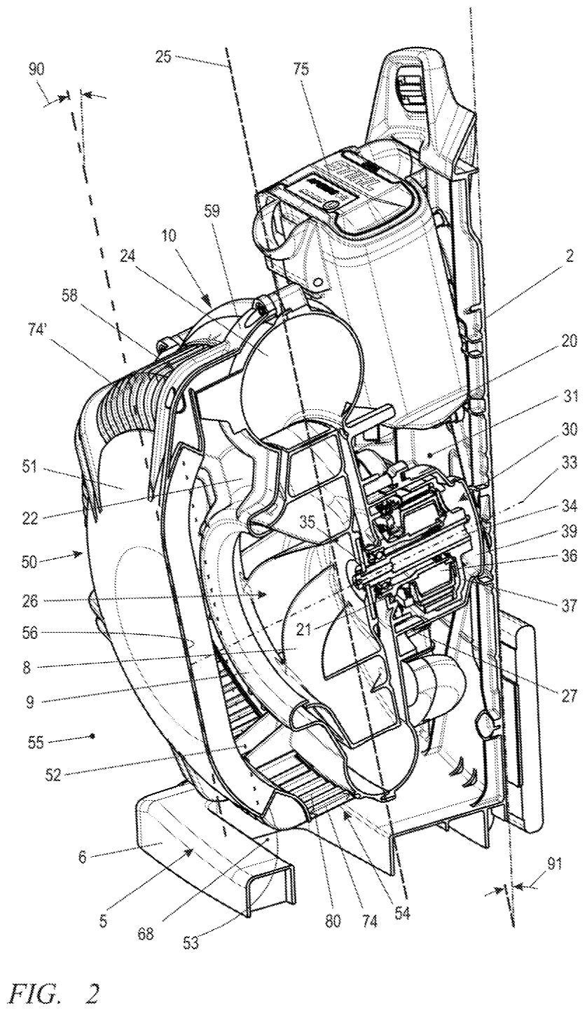

Operating elements, for example a switching lever 17 (for example with the function of an “accelerator”), a switching lever lock 18, or further suitable operating elements 19, are provided in the handle 13. The operating elements by way of a connecting line 7 are connected to control electronics 40 for operating an electric motor 30 (FIG. 2). The energy required for operating the electric motor 30 is provided by a battery pack 75. The battery pack 75 is held in an installation space 31 between the blower spiral 10 and the back plate 2. Two battery packs are provided next to one another in the embodiment shown.

As is shown in FIG. 2, the blower spiral 10 has a spiral channel 24 which opens into the outlet 11. The fan wheel 8 rotates in the center 26 of the spiral channel 24, wherein the center 26 is delimited by a first axial end wall 20 and a second axial end wall 22. The fan wheel 8 is disposed between the axial end walls 20, 22. The first axial end wall 20 lies opposite the back plate 2, so as to be spaced apart therefrom, as a result of which the installation space 31 is formed, the latter beside serving for receiving battery packs 75 also serving for receiving a drive. The second axial end wall 22 lies on the side of the blower spiral 10 that faces away from the back plate 2.

The fan wheel 8 is in the embodiment shown driven by the electric motor 30 which is held in the installation space 31 on the first axial end wall 20 of the blower spiral 10. The drive shaft 34 of the electric motor 30 protrudes through a shaft opening 21 in the first axial end wall 20 of the blower spiral 10 and into the center 26 of the blower spiral 10. The inwardly protruding end section 35 of the drive shaft 34 is connected in a rotationally fixed manner to the fan wheel 8.

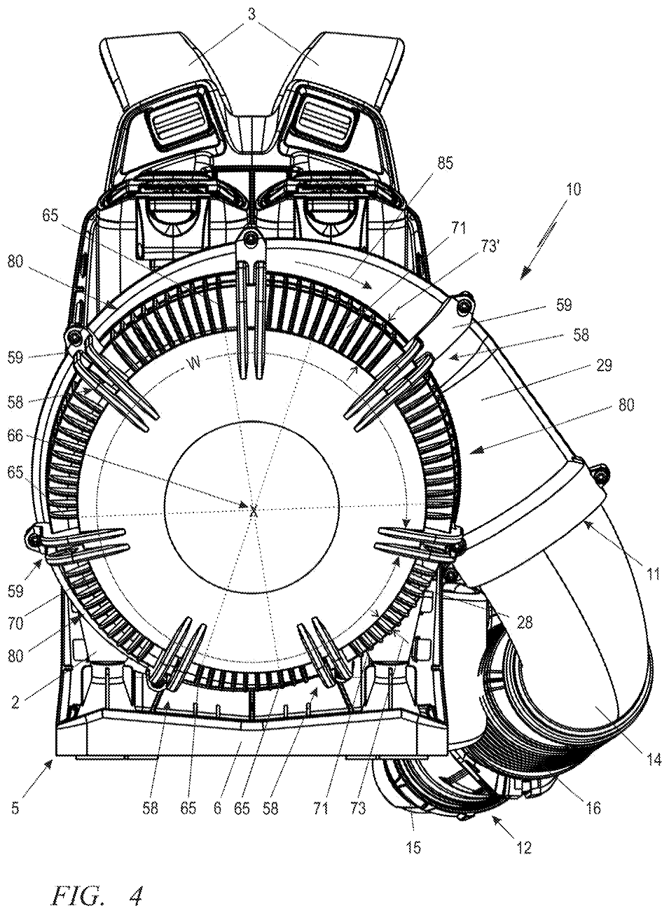

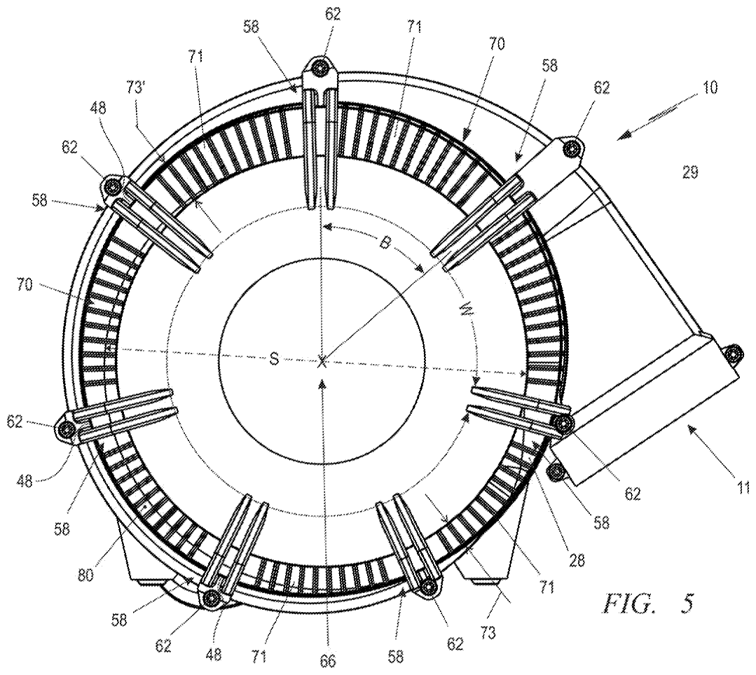

An intake opening 9 by way of which ambient air is inducted axially into the fan wheel 8 and is conveyed radially into the spiral channel 24 is configured in the second axial end wall 22. The spiral channel 24 widens from a first end 28 to the second end 29 of the spiral channel 24 (FIGS. 4, 5). The second end 29 forms the outlet 11 of the spiral channel 24. The operating air which is inducted axially through the intake opening 9 is inducted from the environment 55 of the blower apparatus 1 and is fed to the outlet 11 and to the blower tube 12 by way of the spiral channel 24.

The electric motor 30 is a so-called external rotor motor, that is, the stator 36 lies within the rotor 37. The drive shaft 34, which is connected to the rotor 37, penetrates the stator 36. The drive shaft 34 is mounted in a central sleeve of a support flange of the electric motor 30 and is preferably held so as to be axially secured.

The electric motor 30 can be received in a motor housing 39 which is established on, in particular plug-fitted to, an annular housing mount 27 of the axial end wall 20. The plug connection between the motor housing 39 and the housing mount 27 can include a form-fitting housing safety lock. The motor housing 39 is advantageously open at the end side, and is in particular closed by the axial end wall 20 of the blower spiral 10.

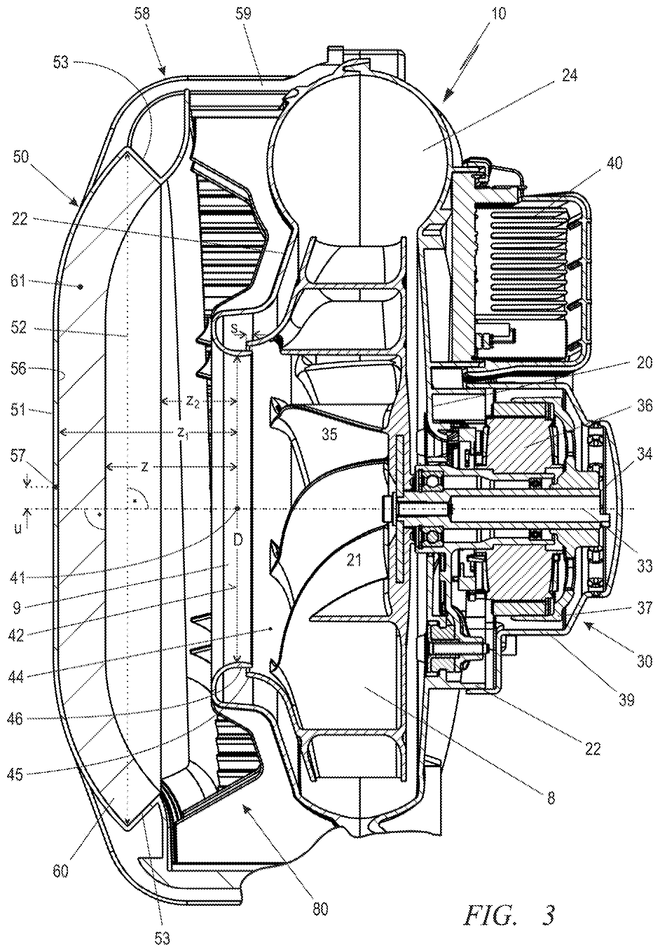

The intake opening 9 has an air inlet surface 42 (FIG. 3). The intake opening 9 is configured so as to be adapted to the air inlet opening 44 of the fan wheel 8. As is shown in FIGS. 2 and 3, the intake opening 9 in the embodiment shown is provided with a collar 46 which is bent towards the fan wheel 8, the collar 46 protruding into the air inlet opening 44 of the fan wheel 8. The collar 46 and the circumferential edge 45 of the air inlet opening 44 are preferably congruent. A type of gap seal is formed by the overlap s (FIG. 3), the gap seal preventing any short circuit in the flow between the spiral channel 24 and the intake opening 9.

The arrangement is chosen such that the rotation axis 33 of the drive shaft 34 is perpendicular to the air inlet surface 42. In particular, the rotation axis 33 of the drive shaft 34 is perpendicular on the air inlet surface 42. The rotation axis 33 of the drive shaft 34 intersects the air inlet surface 42 in the center point 41 of the intake opening 9.

Disposed in front of the intake opening 9 of the blower spiral 10 is a cover element 50 which in the embodiment shown is configured as a cover plate 51. The cover surface 52 of the cover element 50, or of the cover plate 51, respectively, is configured so as to be larger than the air inlet surface 42 of the intake opening 9. The cover plate 51 has a spacing z from the air inlet surface 42 of the intake opening 9. The cover plate 51 has an outer plate edge 53. A gap, in particular an annular gap 54, is configured between the plate edge 53 of the cover plate 51 and the blower spiral 10, in particular the spiral channel 24 of the blower spiral 10. The annular gap 54 forms an intake channel 80 for the operating air of the blower apparatus 1. Direct access of ambient air from the environment 55 of the blower apparatus 1 to the intake opening 9 of the blower spiral 10 is provided by way of the annular gap 54.

As is shown in particular in FIGS. 4 to 7, the annular gap 54 has a size which is variable in the circumferential direction of the intake opening 9. The annular gap 54 is configured between the blower spiral 10, or between the plate edge 53, and the spiral channel 24, respectively. As is shown in the figures of the embodiment, the spiral channel extends across approximately 360°, wherein the end 28 of the spiral channel 24 that is distal from the outlet 11 has a smaller channel cross section than the other end 29 of the spiral channel 24 that opens into the outlet 11. The other end 28 of the spiral channel 24 that opens into the outlet 11 has a channel cross section which is larger by a multiple than the end 26 of the spiral channel 24 that is distal from the outlet 11. The channel cross section of the end 29 of the spiral channel 24 that lies at the outlet 11 is preferably at least 1.2 times to 3 times larger than the channel cross section of the

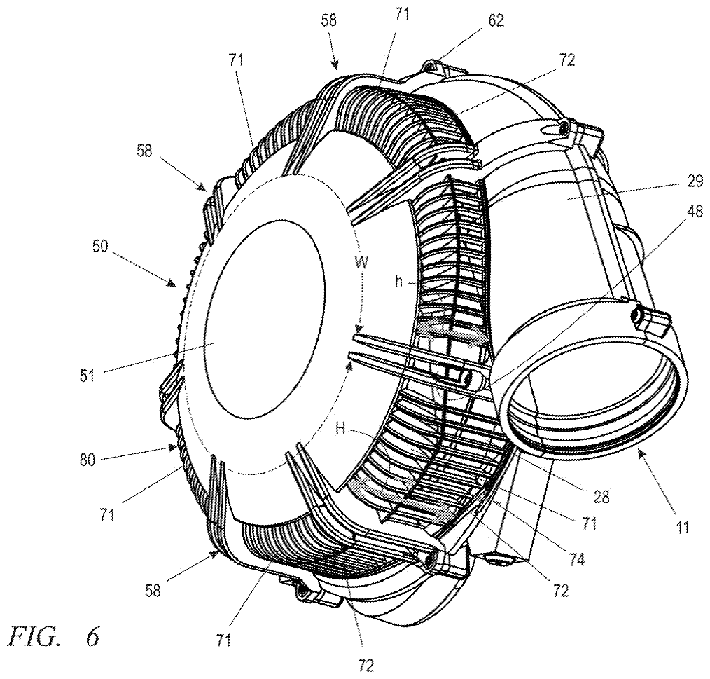

As is shown in particular in FIG. 6, the end 28 of the spiral channel 24 that in the flow direction 85 of the spiral channel 24 is distal from the outlet 11 is in terms of construction distal from the end 29 by a rotation angle of approx. 320° to 360°. The annular gap 54 configured between the plate edge 53 of the cover plate 51 and the blower spiral 10 is larger in the region of the end 28 of the spiral channel 24 than in the region of the end 29 that opens into the outlet 11. The annular gap 54 in the region of the end 28 has a height H (FIG. 6) which is greater than the height h in the region of the end 29 of the spiral channel 24 that opens into the outlet 11.

The cover plate 51 is expediently disposed in such a manner that the center point 57 thereof is higher by a spacing u than the center point 41 of the intake opening 9, or of the air inlet surface 42, respectively. As is shown in FIG. 3, the center point 57 of the cover plate 51 is higher by a spacing u than the rotation axis 33 of the drive shaft 34 of the electric motor 30.

The cover plate 51 is in particular configured in such a manner that the base 56 thereof has a larger spacing z1 from the intake opening 9, or the air inlet surface 42 thereof, respectively, than the plate edge 53 which is at a spacing z2 from the intake opening 9, or the air inlet surface 42 thereof, respectively. The cover plate 51 is preferably configured having a raised plate edge 53. The configuration is chosen in a simple manner such that the cover plate 51 is configured so as to be curved, wherein the concave side of the curvature faces the intake opening 9.

In a preferred embodiment it is provided that an acoustic insulation element 60 is disposed on the inside of the cover plate 51. The plate edge 53 is expediently configured in such a manner that the insulation element 60 is held on the cover plate 51 by the plate edge 53, without additional fastening means being required. The cover plate 51 forms a support of the insulation element 60. In the embodiment shown, the plate edge 53 constricts the concavely curved inside of the cover plate 51 such that the insulation element 60 is reliably held on the inside of the cover plate 51 by the plate edge 53. The insulation element 60 is advantageously composed of an insulation mat 61, in particular a single-part insulation mat, and is held so as to be fixed to the cover plate 51.

As a result of the cover plate 51, and in particular of the insulation element 60 disposed on the cover plate 51, the emission of noise from the intake opening 9 to the environment is reduced. In a particular refinement of the disclosure, it is provided that the cover plate 51 is not disposed parallel to the back plate 2 but is provided so as to be inclined by an inclination angle 90 in relation to the back plate 2. The inclination angle 90 is in particular between 3° to 20°. In an advantageous embodiment, the inclination angle is 10°.

As is shown in FIG. 2, the arrangement is preferably chosen such that the blower spiral 10 held on the back plate 2 is disposed in such a manner that a plane 25 through the blower spiral 10 is at an inclination angle 91 of between 3° to 20° in relation to the back plate 2. The inclination angle 91 of the blower spiral 10 and the inclination angle 90 of the cover plate 51 in relation to the back plate 2 are preferably of identical configuration. In the case of identical inclination angles 90 and 91, the rotation axis 33 of the drive shaft 34 of the electric motor 30 is perpendicular to the cover plate 51, in particular to the base 56 of the cover plate 51.

By way of the inclined arrangement at an inclination angle 90 or 91, respectively, it is achieved that noise emanating from the annular gap 54 has a direction that leads away from the head of a user carrying the blower apparatus on his/her back. For the user carrying the blower apparatus on his/her back the blower apparatus is subjectively quieter than if the inclination angle 90 or 91, respectively, were chosen to be 0°.

The cover plate 51 has fastening elements 58 which are in particular integrally attached, wherein a fastening element 58 is preferably configured as a fastening foot 59. A cutout 48 by way of which ambient air can enter the annular gap 54 is expediently provided in a fastening element 58. The effective inflow surface of the annular gap 54 is only slightly affected.

As is shown in FIG. 5, a plurality of fastening elements 58 are provided across the circumference of the cover plate 51, the fastening elements 58 in particular being at identical mutual angular spacings B. The angular spacings B are in a range between 45° and 60°. Provided across the circumference of the cover plate 51 in the embodiment shown are seven fastening elements 58. One cutout 48 as an inflow opening for ambient air into the annular gap 54 is expediently configured in each fastening element 58.

As is shown in particular in FIG. 3, a fastening element 58 configured as a fastening foot 59 bridges the spacing between the cover plate 51 and the blower spiral 10. Each fastening element 58 by way of the free end section thereof is established on the blower spiral 10, in particular fixed to the latter by a fastening screw 62.

According to an embodiment of the disclosure, the annular gap 54 between the plate edge 53 and the blower spiral 10 is provided with a protective mesh 70. The protective mesh 70 includes a multiplicity of ribs 65 which are disposed at a mutual spacing in the circumferential direction of the plate edge 53. The spacings between the ribs 65 are preferably of identical configuration. The ribs 65 are in particular aligned radially in relation to a center 66 of the cover element 50 (FIG. 4). The protective mesh 70 is composed substantially of a radial cover section 71, which extends in the extension of the cover plate 51, and of an axial cover section 72 which extends in the direction of the rotation axis 33. The axial cover section 72 bridges the spacing between the cover plate 51 and the blower spiral 10. As can be derived from the view according to FIG. 5, the radial cover sections 71 may have dissimilar radial extensions 73. In this way, a radial cover section 71, which is adjacent to the outlet 11 of the blower spiral and, in terms of the extent 73 thereof, is of a shorter configuration than the extent 73′ of another cover section 71 that lies opposite the center of the cover plate 51. It can be expedient for the ribs 65 to also extend beyond the plate section of the cover element 50 that is adjacent to the plate edge 53.

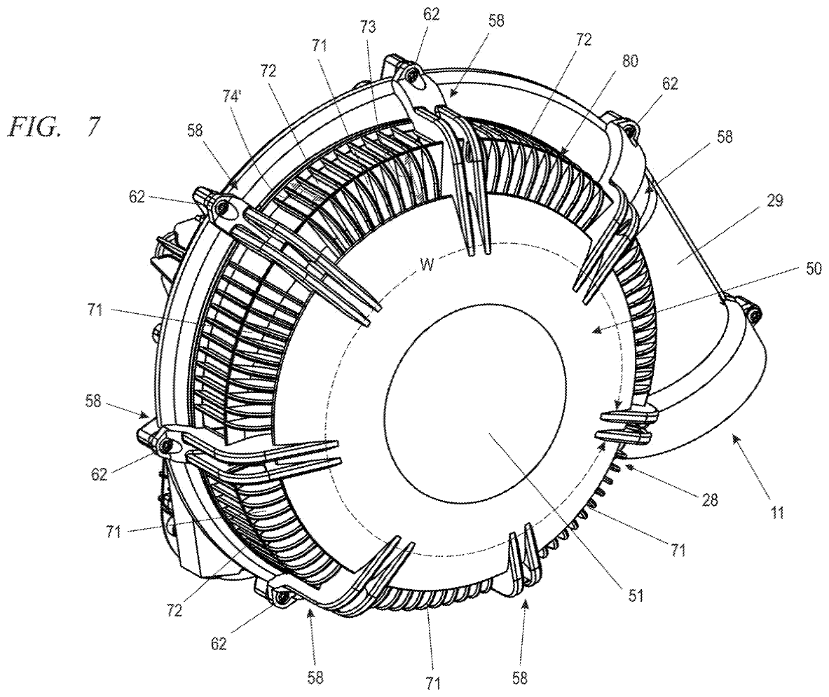

The axial extent 74 of an axial cover section 72 is configured so as to be dissimilarly sized across the circumference of the cover plate 51, as is shown in FIG. 6. In this way, the axial extent 74 in the region below the outlet 11 is larger than the axial extent 74′ of an axial cover section 72 that lies opposite the center of the cover plate 51, as is shown in FIG. 7.

The protective mesh 70 assembled from the cover sections 71 and 72, and the fastening elements 58 of the cover element 50, conjointly with the cover plate 51 are of an integral configuration. The cover element 50 is in particular an integral injection-moulded part which by the fastening elements 58 is established on the blower spiral 10. The annular gap 54 protected by the protective mesh 70 forms an intake channel 80 by way of which the intake opening 9 in the axial end wall 22 of the blower spiral 10 is connected directly to the ambient air of the environment 55 of the blower apparatus 1. The intake channel 80 extends substantially across the entire circumference of the cover plate 51, having a circumferential angle of up to 360°. The intake channel 80 in the circumferential direction has multiple interruptions as a result of the fastening feet 59. The entry cross section of the intake channel 80 is in each case impeded by one fastening foot 59 in only a very small circumferential angle of 3° to 10°, in particular 6° . In the case of the number of seven fastening elements 58 shown, the intake channel 80 is interrupted across an entire circumferential angle of approx. 20° to 70°, in particular 40° . In the embodiment shown, the intake channel 80 extends across a circumferential angle W of 280° to 340°, in particular across 318°.

It is understood that the foregoing description is that of the preferred embodiments of the invention and that various changes and modifications may be made thereto without departing from the spirit and scope of the invention as defined in the appended claims.

1. An electric blower apparatus comprising:
a blower spiral having a first axial end wall, a second axial end wall, and a blower air outlet;
an electric motor disposed on said first axial end wall;
a fan wheel configured to rotate in said blower spiral;
said electric motor having a drive shaft connected to said fan wheel;
said second axial end wall of said blower spiral defining an intake opening;
said intake opening defining an air inlet surface;
a cover element disposed in front of said air inlet surface;
said cover element defining a cover surface disposed at a spacing (z) from said air inlet surface;
said cover surface being configured so as to be larger than said air inlet surface;
said intake opening being connected to an air intake channel configured to feed ambient air from an environment of the electric blower apparatus;
said cover element being configured as a cover plate having an encircling outer plate edge;
said encircling outer plate edge and said blower spiral mutually defining an annular gap between each other; and,
said annular gap forming said intake channel for direct access of ambient air from the environment of the blower apparatus into said intake opening.

2. The blower apparatus of claim 1 further comprising an insulation element disposed between said cover plate and said intake opening.

3. The blower apparatus of claim 2, wherein said cover plate is configured as a support of said insulation element.

4. The blower apparatus of claim 1, wherein said cover plate has a base; and, said encircling outer plate edge is raised in relation to said base.

5. The blower apparatus of claim 4, wherein said base is at a greater spacing (z1) from said air inlet surface of said intake opening than said encircling outer plate edge.

6. The blower apparatus of claim 1, wherein said cover plate is curved.

7. The blower apparatus of claim 6, wherein said cover plate has a concave side facing said intake opening.

8. The blower apparatus of claim 1, wherein said drive shaft defines a rotation axis; and, said rotation axis is perpendicular to said base of said cover plate.

9. The blower apparatus of claim 1, wherein said blower spiral is held on a back plate; and, said cover plate is inclined by an inclination angle in relation to said back plate.

10. The blower apparatus of claim 9, wherein said inclination angle lies in a range between 3° and 20°.

11. The blower apparatus of claim 9, wherein said inclination angle is 10°.

12. The blower apparatus of claim 1, wherein said intake opening defines an intake opening diameter; said cover plate defines a maximum diameter (S) of said cover plate measured at a height level of said encircling outer plate edge; and, said maximum diameter (S) is 1.5 to 3.5 times said intake opening diameter.

13. The blower apparatus of claim 1, wherein said intake opening defines an intake opening diameter; said cover plate defines a maximum diameter (S) of said cover plate measured at a height level of said encircling outer plate edge; and, said maximum diameter (S) is 2.6 times said intake opening diameter.

14. The blower apparatus of claim 1, wherein said annular gap extends across a circumferential angle (W) of up to 360° and said intake channel extends across at least 60% to 80% of said circumferential angle (W).
